(19) United States
(12) Patent Application Publication
(10) Pub. No.: US 2016/0155117 A1
(43) Pub. Date: Jun. 2, 2016

(54) ENABLING PAYMENTS TO BE PROCESSED BY ONLY ONE MERCHANT

(71) Applicant: VISA INTERNATIONAL SERVICE ASSOCIATION, San Francisco, CA (US)

(72) Inventor: Cornelius Johannes Badenhorst, Eversdal (ZA)

(21) Appl. No.: 14/906,506

(22) PCT Filed: Jul. 25, 2014
(86) PCT No.: PCT/IB2014/063410

§ 371 Date: Jan. 20, 2016

(30) Foreign Application Priority Data
Jul. 31, 2013 (ZA) 2013/05763

(51) Int. Cl. G06Q 20/36; G06Q 20/40

(52) U.S. Cl. CPC G06Q 20/3672; G06Q 20/401; G06Q 20/3674; G06Q 2220/00

(57) ABSTRACT

Systems and methods for enabling payments to be processed against an account identifier by only one merchant are provided. In a method, a remotely accessible server obtains an account identifier and stores the account identifier in a database in response to a consumer electing to generate an account identifier. The server receives a request originating from an acquiring entity to process a payment against the account identifier and a merchant identifier of a merchant in favor of which the payment is to be processed. The server looks up the account identifier and stores the merchant identifier in the database in association with the account identifier, linking the account identifier to the merchant. Upon subsequent payment requests against the account identifier in favor of a merchant, the server receives a merchant identifier and, if the merchant identifier matches the merchant identifier associated with the account identifier, the server allows the payment.

### CROSS-REFERENCES TO RELATED APPLICATIONS

This application claims priority to South African provisional patent application number 2013/05763 entitled “System and Method for Recurring Payments”, filed on 31 Jul. 2013, which is incorporated by reference herein.

### BACKGROUND

Systems and methods exist for issuing payment credentials to a consumer which are only valid for a single use or for a relatively short timeframe. Such credentials are typically referred to as “dynamic payment credentials”.

In one example of such a system, a consumer requests payment credentials using an electronic device, typically a mobile phone. If the request is authorized, payment credentials in the form of a single-use Primary Account Number (PAN), also referred to as a one-time PAN, is issued to the consumer. The consumer may then provide the PAN to a merchant in order to conduct a transaction. After the transaction has been processed, or after a predefined period of validity, the PAN can no longer be used to conduct a transaction.

A notable disadvantage of these and similar systems is that the single-use nature of the payment credentials prevents it from being used for a recurring transaction. In the case where a consumer desires to conduct a recurring transaction, for example subscribe to and purchase a monthly magazine, the consumer is required to request, obtain and present new single-use payment credentials for each monthly payment.

Methods of processing recurring payments commonly involve a consumer providing conventional payment card details, in other words, credentials the validity of which are not restricted to a specific number of uses or a relatively short timeframe, to a merchant in order to authorize a recurring direct debit. However, these instructions may be difficult to modify or revoke. Additionally, these methods may present the risk of an unscrupulous party obtaining payment credentials of a consumer and conducting or attempting to conduct fraudulent transactions.

Embodiments of the invention aim to alleviate these and other problems at least to some extent.

In the remainder of this specification, the term “merchant” should be interpreted so as to have its widest meaning, and the term includes any party or entity acting as a payee in a financial transaction.

### BRIEF SUMMARY

In accordance with the invention there is provided a method of enabling payments to be processed against an account identifier by only one merchant, the method carried out at a remotely accessible server and comprising: in response to a consumer electing to generate an account identifier, obtaining an account identifier and storing the account identifier in a database as an unlinked account identifier; receiving a request originating from an acquiring entity to process a payment transaction against the account identifier; receiving a merchant identifier of a merchant in favor of which the payment transaction is to be processed; looking up the account identifier in the database; storing the merchant identifier in the database in association with the account identifier so as to link the account identifier to the merchant; and upon subsequent requests originating from an acquiring entity to process a payment transaction against the account identifier: receiving a merchant identifier of a merchant in favor of which the subsequent payment transaction is to be processed; and if the merchant identifier of the merchant in favor of which the subsequent payment transaction is to be processed matches the merchant identifier associated with the account identifier, allowing the payment transaction to proceed; or if the merchant identifier of the merchant in favor of which the subsequent payment transaction is to be processed does not match the merchant identifier associated with the account identifier, declining the payment transaction.

Further features provide for the step of storing the merchant identifier in the database in association with the account identifier to include storing the merchant identifier in association with the account identifier only if the account identifier has not previously been used to process a payment transaction; and for the step of storing the merchant identifier in the database in association with the account identifier to be followed by the step of allowing the payment transaction to proceed.

Yet further features provide for the account identifier to include a primary account number (PAN); for at least part of the account identifier to be formatted as a primary account number (PAN); and for the account identifier to be a token associated with a financial account of the consumer.

Still further features provide for the step of obtaining the account identifier to include requesting a token generator to generate the account identifier and receiving the account identifier from the token generator; for the token to be associated with actual payment credentials for the financial account of the consumer; and for the actual payment credentials to be used to process the payment transaction if the payment transaction is allowed to proceed.

The account identifier may be associated and replaced with actual payment credentials if the payment transaction is allowed to proceed, and the account identifier may be one or a combination of: a bank account number, a PAN, a pseudo-PAN, an obfuscated PAN, an alias, a card expiry date, a Card Verification Value (CVV), a passcode, a passphrase, a Personal Identification Number (PIN), a barcode, and a Quick Response (QR) code.

Further features provide for the step of obtaining the account identifier to include generating the account identifier at the remotely accessible server; for the payment transaction to be processed to be a recurring payment; for the remotely accessible server to be operated by a mobile payment system; for the consumer to elect to generate the account identifier via an electronic device of the consumer; and for an identifier of the electronic device to serve as a consumer identifier.

The consumer may be a consumer having a mobile money account held at the mobile payment system. The identifier of the electronic device of the consumer may be a Mobile Subscriber Integrated Services Digital Network Number (MSISDN) of a mobile phone of the consumer.

Even further features provide for the step of storing the account identifier in the database to include associating the account identifier with a consumer identifier of the consumer; for the method to include the step of receiving a consumer identifier so as to identify a consumer record against which to store the account identifier; for the step of receiving a merchant identifier of a merchant in favor of which the payment transaction is to be processed to include the step of receiving from the acquiring entity a consumer identifier of a consumer initiating the payment transaction.

The invention extends to a system for enabling payments to be processed against an account identifier by only one merchant, comprising a remotely accessible server including: an account identifier component for, in response to a consumer electing to generate an account identifier, obtaining an account identifier and storing the account identifier in a database as an unlinked account identifier; a processing request component for receiving a request originating from an acquiring entity to process a payment transaction against the account identifier; a merchant identifier component for receiving a merchant identifier of a merchant in favor of which the payment transaction is to be processed; a look-up component for looking up the account identifier in the database; a linking component for storing the merchant identifier in the database in association with the account identifier so as to link the account identifier to the merchant; and an authorization component for, upon subsequent requests originating from an acquiring entity to process a payment transaction against the account identifier and in response to receiving a merchant identifier of a merchant in favor of which the subsequent payment transaction is to be processed: if the merchant identifier of the merchant in favor of which the subsequent payment transaction is to be processed matches the merchant identifier associated with the account identifier, allowing the payment transaction to proceed; or if the merchant identifier of the merchant in favor of which the subsequent payment transaction is to be processed does not match the merchant identifier associated with the account identifier, declining the payment transaction.

The system may further comprise a token generator, and the step of obtaining an account identifier performed by the account identifier component of the remotely accessible server may include requesting the token generator to generate the account identifier and receiving the account identifier from the token generator. The account identifier may be a token associated with a financial account of the consumer, and the token generator may be an issuer of the financial account of the consumer.

The invention further extends to a system for enabling payments to be processed against an account identifier by only one merchant, comprising an electronic device of a consumer in communication with a remotely accessible server, the electronic device including: an electing component for receiving input from the consumer indicating election to generate an account identifier; a transmitting component for transmitting a request for an account identifier, the remotely accessible server obtaining the account identifier in response to the request; and a receiving component for receiving the account identifier such that the account identifier can subsequently be provided to a merchant in favor of which a payment transaction is to be processed.

Further features provide for the electronic device of the consumer to be a mobile phone; for the remotely accessible server to be operated by a mobile payment system; and for an identifier of the mobile phone to serve as a consumer identifier.

The invention yet further extends to a computer program product for enabling payments to be processed against an account identifier by only one merchant, the computer program product comprising a computer-readable medium having stored computer-readable program code for performing the steps of: in response to a consumer electing to generate an account identifier, obtaining an account identifier and storing the account identifier in a database as an unlinked account identifier; receiving a request originating from an acquiring entity to process a payment transaction against the account identifier; receiving a merchant identifier of a merchant in favor of which the payment transaction is to be processed; looking up the account identifier in the database; storing the merchant identifier in the database in association with the account identifier so as to link the account identifier to the merchant; and upon subsequent requests originating from an acquiring entity to process a payment transaction against the account identifier: receiving a merchant identifier of a merchant in favor of which the subsequent payment transaction is to be processed; and if the merchant identifier of the merchant in favor of which the subsequent payment transaction is to be processed matches the merchant identifier associated with the account identifier, allowing the payment transaction to proceed; or if the merchant identifier of the merchant in favor of which the subsequent payment transaction is to be processed does not match the merchant identifier associated with the account identifier, declining the payment transaction.

The computer-readable medium may be a non-transitory computer-readable medium, and the computer-readable program code may be executable by a processing circuit.

In order for the invention to be more fully understood, implementations thereof will now be described with reference to the accompanying drawings.

### BRIEF DESCRIPTION OF THE DRAWINGS

FIG. 1A is a schematic diagram illustrating an embodiment of a system for enabling payments to be processed against an account identifier by only one merchant according to the invention;

FIG. 1B is a block diagram which illustrates an embodiment of a remotely accessible server of a system for enabling payment transactions to be processed against an account identifier by only one merchant according to the invention;

FIG. 1C is a block diagram which illustrates an embodiment of an electronic device of a system for enabling payment transactions to be processed against an account identifier by only one merchant according to the invention;

FIG. 2A is a swim-lane flow diagram illustrating a method of enabling payments to be processed against an account identifier by only one merchant according to the invention;

FIG. 2B is a swim-lane flow diagram which illustrates a subsequent payment being processed against an account identifier by only one merchant;

FIG. 3 is a flow diagram which illustrates an exemplary implementation of a method of enabling payments to be processed against an account identifier by only one merchant;

FIG. 4 illustrates a block diagram of a mobile device that can be used in various embodiments of the invention; and,

FIG. 5 illustrates a block diagram of a computing device in which various aspects of the invention may be implemented.

### DETAILED DESCRIPTION WITH REFERENCE TO THE DRAWINGS

Systems and methods for enabling payments to be processed against an account identifier by only one merchant are provided. A system may provide a remotely accessible server which may obtain an account identifier and store the account identifier in a database as an unlinked account identifier. Subsequently, the remotely accessible server may receive a request originating from an acquiring entity to process a payment transaction against the account identifier. The remotely accessible server may also receive a merchant identifier of a merchant in favor of which the payment transaction is to be processed. The remotely accessible server may then look up the account identifier in the database and store the merchant identifier in the database in association with the account identifier so as to link the account identifier to the merchant.

Later in time and upon subsequent requests originating from an acquiring entity to process a payment transaction against the account identifier, the remotely accessible server may receive a merchant identifier of a merchant in favor of which the subsequent payment transaction is to be processed. If the merchant identifier of the merchant in favor of which the subsequent payment transaction is to be processed matches the merchant identifier associated with the account identifier, the remotely accessible server may allow the payment transaction to proceed. Alternatively, if the merchant identifier of the merchant in favor of which the subsequent payment transaction is to be processed does not match the merchant identifier associated with the account identifier, the remotely accessible server may decline the payment transaction.

Thus embodiments of the described systems and methods provide that an account identifier, which may typically be requested by a consumer for use in conducting a transaction which the consumer expects to recur, can be linked or tied to a particular merchant such that the account identifier is only usable by the consumer at the particular merchant to which it is linked or tied.

The account identifier may take on various forms. The account identifier, which may also be referred to as a single-merchant token in that it becomes linked to a single merchant, may represent actual payment credentials such as a payment account number of the consumer associated with a financial account held at an issuing entity. The account identifier may be pseudo-card details which are associated to and replaced with actual payment credentials if the transaction is allowed to proceed.

The account identifier may include any one or more of the group of: a payment token associated with a financial account of a consumer or payment credentials of the consumer; a bank account number; a primary account number (PAN); a pseudo-PAN; an obfuscated PAN; an alias; a card expiry date; a Card Verification Value (CVV); a passcode; a passphrase; a Personal Identification Number (PIN); a barcode; a Quick Response (QR) code, and the like.

It is important to note that in embodiments of systems and methods described herein, the account identifier is initially unlinked and thus may be used at any merchant. However, after first use of the account identifier, the account identifier is linked to the particular merchant at which it was first used and thereafter may only be used at that particular merchant. As such, it may be said that the account identifier may have payments processed against it by only one merchant.

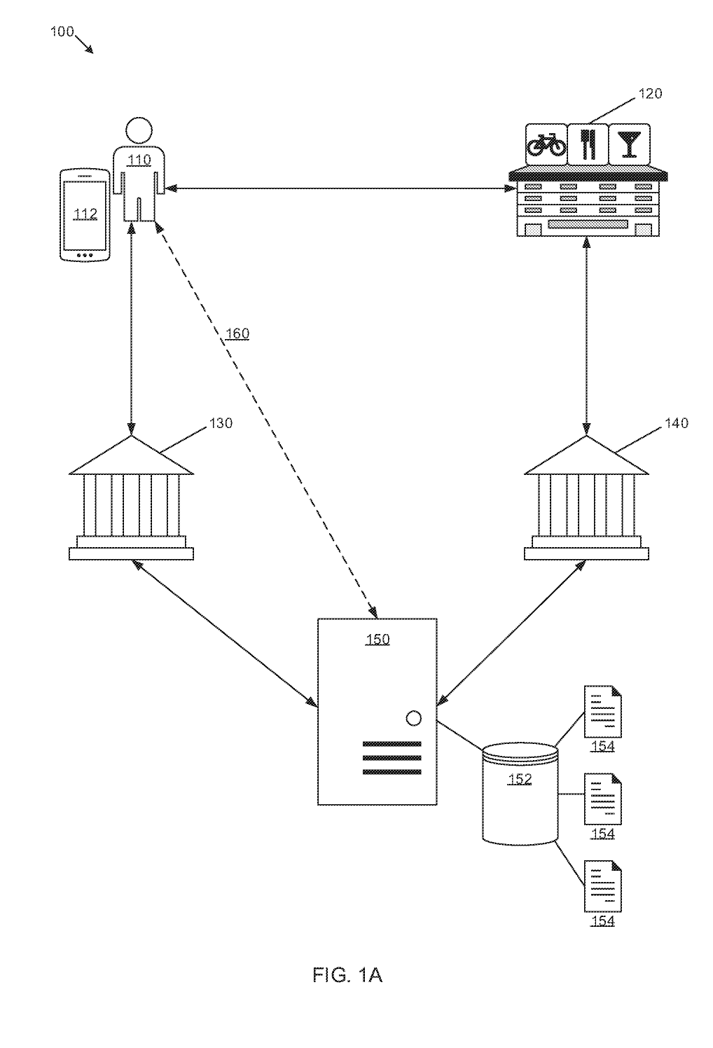

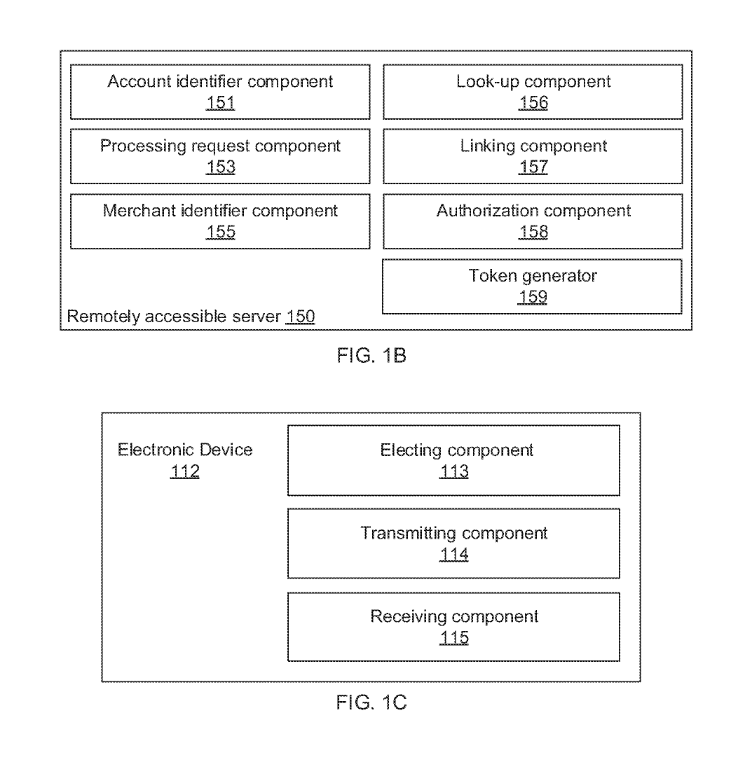

FIG. 1A is a schematic diagram which illustrates an embodiment of a system (100) for enabling payments to be processed against an account identifier by only one merchant. The system (100) may include an electronic device (112) of a consumer (110), a merchant (120), an issuing entity (130), an acquiring entity (140) and a remotely accessible server (150).

The remotely accessible server (150) may be any appropriate server computer, distributed server computer, cloud-based server computer, server computer cluster or the like and may be linked to or may maintain a database (152) containing a plurality of consumer records (154). In one embodiment, the remotely accessible server (150) is a mobile money server of a mobile payment system. In such a case, each consumer (110) may have a registered mobile money account held at the remotely accessible server (150) and the consumer record (154) may contain details thereof, such as a consumer account number, personal information of the consumer, funds available, details of payment instruments, or the like. In further embodiments, the remotely accessible server (150) is a server of a traditional financial institution such as a bank or other financial services provider. In one embodiment, the remotely accessible server (150) is maintained or operated by an issuing bank of the consumer (110).

The electronic device (112) may be any electronic communications device capable of communicating over a communications network, such as a cellular communications network. The term should be interpreted to specifically include all mobile or cellular phones, including so-called “feature phones” and smartphones, and may also include other electronic devices such as computers, laptops, handheld personal computers, personal digital assistants, tablet computers, wearable computing devices, smart household appliances, and the like. In the embodiment of FIG. 1A, the electronic device (112) is a mobile phone of the consumer (110). In some embodiments, an identifier of the electronic device or a communication address of the electronic device may serve as a consumer identifier.

The electronic device (112) may have a software application resident therein and executable thereon such that, when executed by the electronic device, the electronic device is caused to perform operations, such as to prompt a user thereof for input, accept input from the consumer, process the input, communicate via communication network with the issuing entity (130) or remotely accessible server (150), as the case may be, or the like. Responsive to an appropriate consumer input, the electronic device (112) may be configured to receive a consumer input electing to generate an account identifier, transmit a request for an account identifier, receive an account identifier, display a received account identifier, and the like.

It may be that in other embodiments of the invention, functionality of the software application is provided by Unstructured Supplementary Services Data (USSD) bearer channel which may allow the electronic device to communicate with the remotely accessible server via a live communication link. The channel may be initiated by the electronic device responsive to the consumer dialing a short code (for example *123#) or may be initiated by the remotely accessible server. As such the consumer may be prompted for input and receive messages from the remotely accessible server via the USSD channel.

The remotely accessible server (150) is configured to transmit communications to and receive communications from the issuing entity (130) and the acquiring entity (140) over any suitable communications network or networks. As illustrated by the broken line (160) in FIG. 1A, the remotely accessible server (150) may be, in some embodiments, further configured to receive communications from and transmit communications to the electronic device (112) of the consumer (110) over a communications network, which may be, among others, a mobile communications network.

Embodiments of the invention provide for communications transmitted to and from the remotely accessible server (150), the issuing entity (130), the acquiring entity (140), the electronic device (112) and/or the merchant (120) to be secure communications across an encrypted communication channel such as Hypertext Transfer Protocol Secure (HTTPS), Transport Layer Security/Secure Sockets Layer (TLS/SSL) or other secure channel.

The issuing entity (130) may be any appropriate financial entity acting as an issuer to the consumer (110). In some embodiments, the entity may act as a “token generator” being authorized to issue an account identifier being a payment token, preferably in the form of payment credentials, to the consumer (110). Alternatively, the issuing entity (130) may be a secure financial gateway, a mobile money platform, or a payment processing network or system. The acquiring entity (140) is typically an acquiring bank of the merchant (120).

The described system (100) may enable the consumer (110) to request and receive an account identifier, which, in some embodiments, can be used to set up a recurring payment in favor of a single merchant. The schematic diagram of FIG. 1A is for illustrative purposes and while only one consumer, merchant, acquiring entity and issuing entity are shown, it should be appreciated that in a practical implementation there may be many more of each of these.

FIGS. 1B and 1C are schematic diagrams which illustrate a remotely accessible server and electronic device respectively according to embodiments of a system for enabling payment transactions to be processed against an account identifier by only one merchant, such as the system (100) described above with reference to FIG. 1A.

The remotely accessible server (150) illustrated in FIG. 1B may include an account identifier component (151) for, in response to a consumer electing to generate an account identifier, obtaining an account identifier and storing the account identifier in a database as an unlinked account identifier. The account identifier component (151) may also receive an indication that the account identifier is to be linked to a single merchant being the first merchant in whose favor the account identifier is first used to process a payment against.

The remotely accessible server may further include a processing request component (153) for receiving a request originating from an acquiring entity to process a payment transaction against the account identifier. Additionally, the remotely accessible server (150) may include a merchant identifier component (155) for receiving a merchant identifier of a merchant in favor of which the payment transaction is to be processed. In some embodiments, the merchant identifier may be included in the request received from the acquiring entity and the merchant identifier component (155) may obtain the merchant identifier from the request.

The remotely accessible server (150) may further include a look-up component (156) for looking up the account identifier in the database and a linking component (157) for storing the merchant identifier in the database in association with the account identifier so as to link the account identifier to the merchant identifier and, in turn, the merchant.

Furthermore, the remotely accessible server (150) may include an authorization component (158) for either allowing payment transactions to proceed or declining payment transactions. The authorization component (158) may allow an initial payment transaction, in respect of the account identifier, to proceed in response to storing the merchant identifier in the database in association with the account identifier.

The authorization component (158) may be further configured to either allow a subsequent payment transaction in respect of the account identifier to proceed or alternatively decline it. If a merchant identifier of the merchant in favor of which the subsequent payment transaction is to be processed matches the merchant identifier associated with the account identifier, the authorization component (158) may allow the payment transaction to proceed. Alternatively, if the merchant identifier of the merchant in favor of which the subsequent payment transaction is to be processed does not match the merchant identifier associated with the account identifier, the authorization component (158) may decline the payment transaction.

The remotely accessible server (150) may further include a token generator (159) for generating the account identifier. The account identifier component (151) may obtain an account identifier by requesting the token generator (159) to generate the account identifier and receiving the account identifier therefrom.

The electronic device (112) illustrated in FIG. 1C may be capable of communicating with the remotely accessible server (150) and may include an electing component (113) for receiving input from a consumer indicating election to generate an account identifier.

The electronic device (112) may also include a transmitting component (114) for transmitting a request for an account identifier. The remotely accessible server (150) may then obtain the account identifier in response to the request being transmitted from the electronic device (112).

Additionally, the electric device (112) may provide a receiving component (115) for receiving the account identifier such that the account identifier can subsequently be provided to a merchant in favor of which a transaction is to be processed.

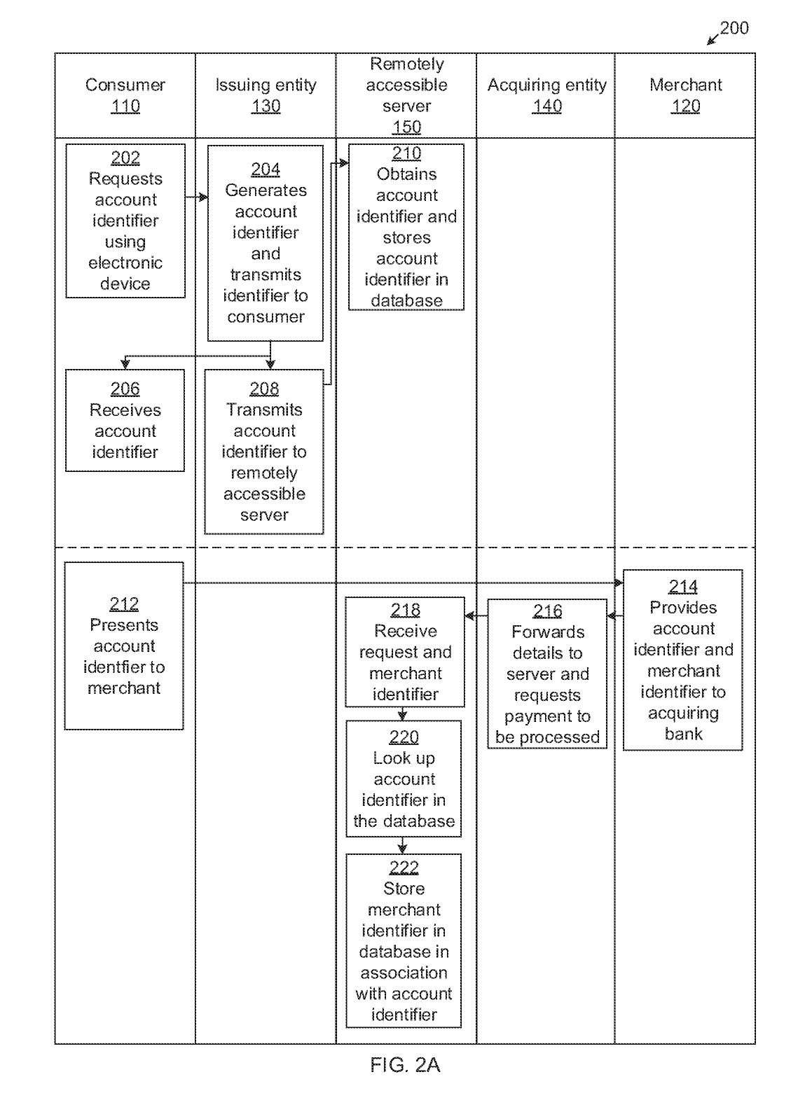

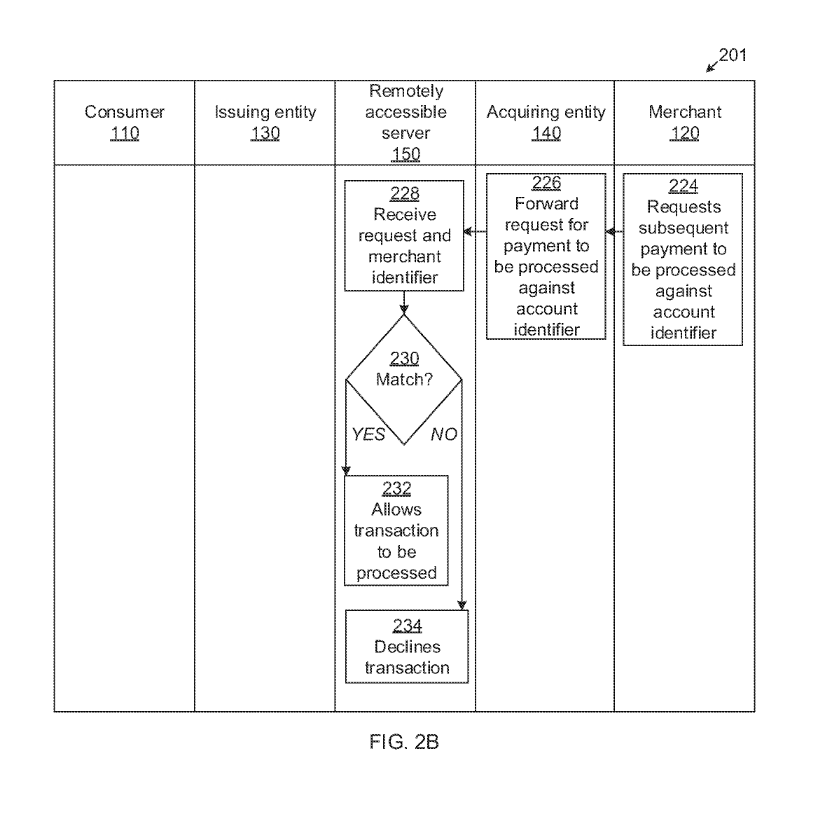

The swim-lane flow diagrams (200, 201) of FIGS. 2A and 2B illustrate methods of enabling payments to be processed against an account identifier by only one merchant. Respective swim-lanes serve to delimit respective steps or methods conducted by a consumer (110), an issuing entity (130), a remotely accessible server (150), an acquiring entity (140) and a merchant (120). While the remotely accessible server (150) and issuing entity (130) are shown in separate swim-lanes, it should be appreciated that in some embodiments, the remotely accessible server (150) may in fact be maintained or operated by the issuing entity (130). In other embodiments, the remotely accessible server may be maintained or operated by a payment processing network.

At a first stage (202), the consumer (110) may use the electronic device (112) to request an account identifier from the issuing entity (130). The request may include an indication of an election by the consumer that the account identifier be usable by only one merchant. Communications between the issuing entity (130) and the electronic device (112) of the consumer (110) may typically be effected by way of Short Message Service (SMS) protocol, Unstructured Supplementary Service Data (USSD) protocol, over a secure Internet connection, or by way of data communication enabled by a software application installed on the electronic device (112) of the consumer (110).

In other embodiments, the consumer (110) may communicate with and request an account identifier directly from the remotely accessible server (150). In such a case, the request is typically received by the remotely accessible server (150) and routed to the issuing entity (130) for generating an account identifier, preferably along with a consumer identifier of the consumer (110) for whom the token is to be generated. Alternatively, an account identifier may be generated by the remotely accessible server (150).

At a next stage (204), the issuing entity (130) generates an account identifier and transmits the account identifier to the electronic device (112) of the consumer (110). For example, and as is the case in a preferred embodiment, the issuing entity (130) generates an account identifier formatted as a Primary Account Number (PAN). The account identifier may also include other necessary payment details such as a card expiry date and a CVV and/or a PIN or passcode to be used when employing the account identifier to make a payment.

The consumer (110) may then receive the account identifier at a next stage (206). As will be made clear in what follows, the account identifier may be used by the consumer (110) for a first payment at any merchant, and becomes linked to that specific merchant after the first payment in a way that recurring payments may be processed against the account identifier for the specific merchant, while no payments may be processed against the account identifier in favor of any other merchant.

Such a recurring payment may, for example, be a recurring direct debit or debit order payment. In other words, the recurring payment may be pre-authorized. However, the account identifier may equally be used to “manually” request a payment to be processed against the token for a merchant, as long as it is the same merchant in favor of which the first payment was processed. In another case, the account identifier may be provided to an e-commerce merchant by the consumer for secure storage thereat so as to enable the consumer to transact with that e-commerce merchant against the account identifier.

At a next stage (208), the issuing entity (130), after having generated the account identifier, transmits the account identifier to the remotely accessible server (150).

The remotely accessible server (150) obtains the account identifier and stores the account identifier in a database as an unlinked account identifier at a following stage (210). In this embodiment of the described method, obtaining the account identifier includes receiving the account identifier from the issuing entity (130). In other embodiments, obtaining the account identifier may include requesting a token generator to generate the account identifier and receiving the account identifier from the token generator. Alternatively the remotely accessible server (150) may include a token generator in which case obtaining the account identifier may include generating the account identifier using the token generator.

Having received the account identifier, the consumer (110) may then present or provide the account identifier to a merchant so as to conduct a payment transaction. At this point it is important to note that in this embodiment, as the account identifier has not yet been linked or tied to a particular merchant, the consumer may present the unlinked account identifier to any one of a number of merchants.

At a next stage (212) then, the consumer (110) presents or provides the account identifier to a merchant (120). The account identifier may be provided to the merchant (120) by the consumer (110) with a view to setting up the recurring payment. For example, the consumer (110) may input the PAN, expiry date and CVV of the received account identifier on a payment page of a secure payment website of the merchant (120). The merchant (120) may initiate a recurring transaction such as the subscription to and purchase of a monthly magazine. Alternatively the account identifier may be stored by the merchant such that the consumer (110) can shop online at the merchant (120) without having to provide an account identifier each time the consumer wishes to make a purchase. It should be appreciated that a once-off payment may, in other embodiments, also be initiated using the account identifier as described above.

The merchant (120) may then, at a next stage (214), provide the account identifier and optionally other details including a transaction value, merchant information, a merchant identifier and the like to the acquiring entity (140). The acquiring entity (140) in turn transmits these details to the remotely accessible server (150) with an instruction to process the payment against the account identifier in favor of the merchant (120), at a next stage (216). The acquiring entity (140) also provides the remotely accessible server (150) with a merchant identifier of the merchant (120) in favor of which the payment is to be processed.

In embodiments of the described method, a consumer identifier of the consumer (110) initiating the payment may also be provided to the remotely accessible server (150). For example, the consumer identifier may be an identifier of the electronic device (112) of the consumer (110), such as a Mobile Subscriber Integrated Services Digital Network Number (MSISDN) of a mobile phone of the consumer (110) and may have been provided by the consumer (110) to the merchant (120) along with the account identifier.

In a stage which follows (218), the remotely accessible server (150) receives the request originating from the acquiring entity (140) to process the payment transaction against the account identifier. The request may also include the account identifier. The remotely accessible server (150) also receives a merchant identifier of a merchant in favor of which the payment is to be processed.

The remotely accessible server (150) then proceeds, at a next stage (220), to look up the account identifier received from the acquiring entity (140) in the database and, at a following stage (222), stores the merchant identifier in the database in association with the account identifier so as to link the account identifier to the merchant (140). In some embodiments, the account identifier may be associated with a consumer identifier of the consumer (110) electing to generate the account identifier and may be stored in a consumer record of the consumer. Furthermore, prior to storing the merchant identifier in the database, the remotely accessible server (150) may first determine that the account identifier is an unlinked account identifier.

Following the stage (222) of storing the merchant identifier in the database in association with the account identifier, the remotely accessible server (150) may, in a next stage, allow the transaction to proceed.

Embodiments of the described method provide that once the account identifier has been linked to, or stored in the database in association with, a merchant identifier of a particular merchant, the account identifier may only be used to process transactions in favor of that particular merchant. Thus any subsequent requests to process a payment transaction against the account identifier will have to be in favor of that particular merchant.

FIG. 2B is a swim-lane flow diagram which illustrates methods in which the account identifier is used in a subsequent transaction following the stages described above with reference to FIG. 2A. In some embodiments, the consumer may have provided the account identifier to the merchant (120) so as to enable the merchant to conduct recurring transactions. Accordingly, the merchant (120) may initiate subsequent payment transaction requests using the account identifier of the consumer (110). Alternatively subsequent transactions may be initiated by the consumer (110), with the consumer providing the account identifier to the merchant (120) so as to initiate the subsequent transaction.

In the embodiment illustrated in FIG. 2B, the merchant has securely stored the account identifier and is operable to conduct recurring transactions against the account identifier. Accordingly, at a first stage (224) in conducting a subsequent transaction, the merchant (120) submits a request to the acquiring entity (140) to process a payment transaction against the account identifier. The request may include the merchant identifier.

The acquiring entity (140), in turn, forwards the request to process a payment transaction against the account identifier to the remotely accessible server (150) at a next stage (226). The acquiring entity (140) may also provide the remotely accessible server (150) with the merchant identifier of the merchant in favor of which the payment is to be processed.

The remotely accessible server (150), at a next stage (228), receives the request to process a payment transaction against the account identifier. The remotely accessible server (150) also receives the merchant identifier of a merchant in favour of which the subsequent payment is to be processed.

At a following stage (230), the remotely accessible server determines whether the merchant identifier of the merchant in favor of which the subsequent payment is to be processed matches the merchant identifier associated with the account identifier in the database. If so, the remotely accessible server (150) may allow the transaction to be processed at a following stage (232). Alternatively, if the merchant identifier of the merchant in favor of which the subsequent payment is to be processed does not match the merchant identifier associated with the account identifier in the database, the remotely accessible server may decline the transaction at an alternate stage (234).

In some embodiments of the described systems and methods, recurring payments in favor of a single merchant may have to be carried out by a specific consumer. In such embodiments, the remotely accessible server (150) may additionally check whether the consumer identifier of a consumer initiating the subsequent payment matches the consumer identifier stored in the database (152) before allowing the transaction to be processed. In such a case, the remotely accessible server (150) may decline the transaction if a different consumer than the consumer who conducted the first payment attempts to process a payment against the account identifier, even if the payment is to be processed in favor of the same merchant. This may serve as an additional security measure.

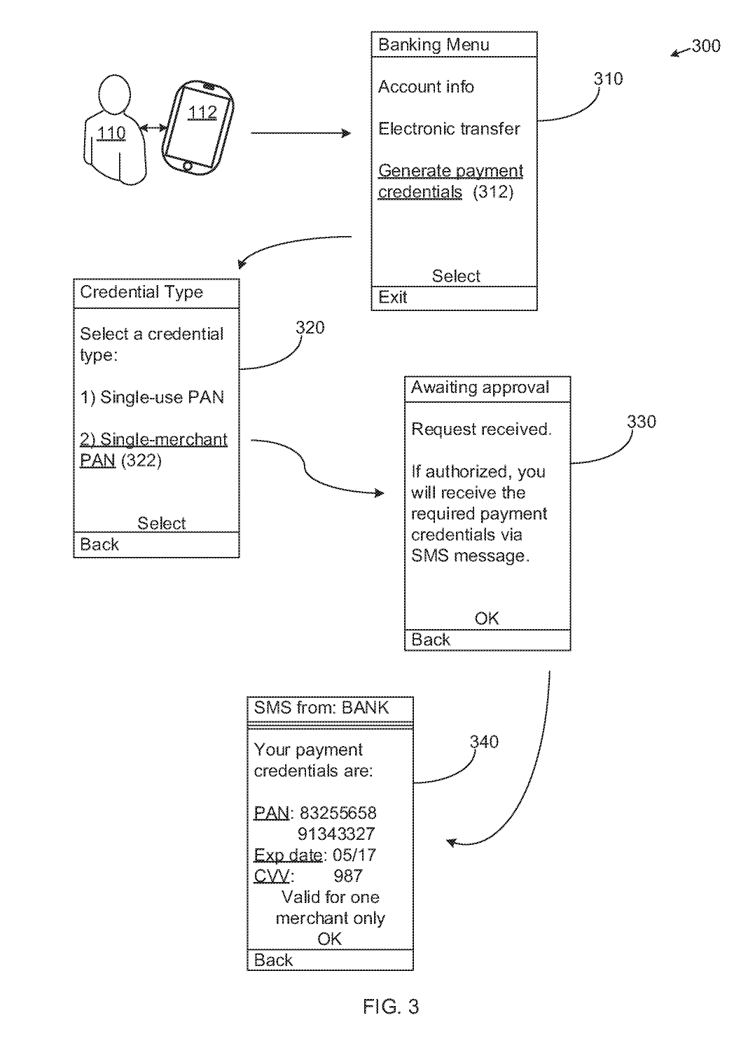

The flow diagram (300) of FIG. 3 illustrates a method in accordance with the invention carried out using the system of FIG. 1.

At a first stage (310), the consumer (110) accesses a banking menu provided as a USSD-based service using the electronic device (112), which is a mobile phone in this embodiment. The consumer (110) is presented with various banking options, and at a next stage (312) opts for the generation of payment credentials.

At a next stage (320), the consumer (110) is required to select a payment credential type required. The consumer (110) desires an account identifier for setting up a recurring payment in favor of a single merchant. Therefore in this case and as an example, the consumer (110) requests a single-merchant PAN for authorizing a recurring e-commerce transaction as described above, and selects the appropriate menu option at a next stage (322).

The consumer (110) is presented, at a further stage (330), with a notification that the request has been received and that authorization thereof is in process. One or more validation steps may, of course, be included between the prior stages (320, 330). For example, the consumer (110) may be required to enter a PIN or perform any suitable method of two-factor or three-factor authentication in order to verify its identity.

The consumer (110) preferably receives the appropriate account identifier via one or more SMS messages. As shown in FIG. 3, at a next stage (340), the consumer (110) is provided with a single-use PAN, a card expiry date and a CVV for use in authorizing the recurring e-commerce transaction. These details may then be provided to the merchant at a first occasion, after which the transaction will automatically be processed on subsequent occasions.

It is foreseen that the consumer (110) may be capable of cancelling or invalidating an account identifier after the generation thereof. For example, the consumer (110) may select a “Cancel account identifier” option on a banking menu similar to the banking menus shown in FIG. 3. Once the account identifier is cancelled or invalidated, the remotely accessible server (150) updates the database (152) accordingly and no further payments may be processed against the account identifier.

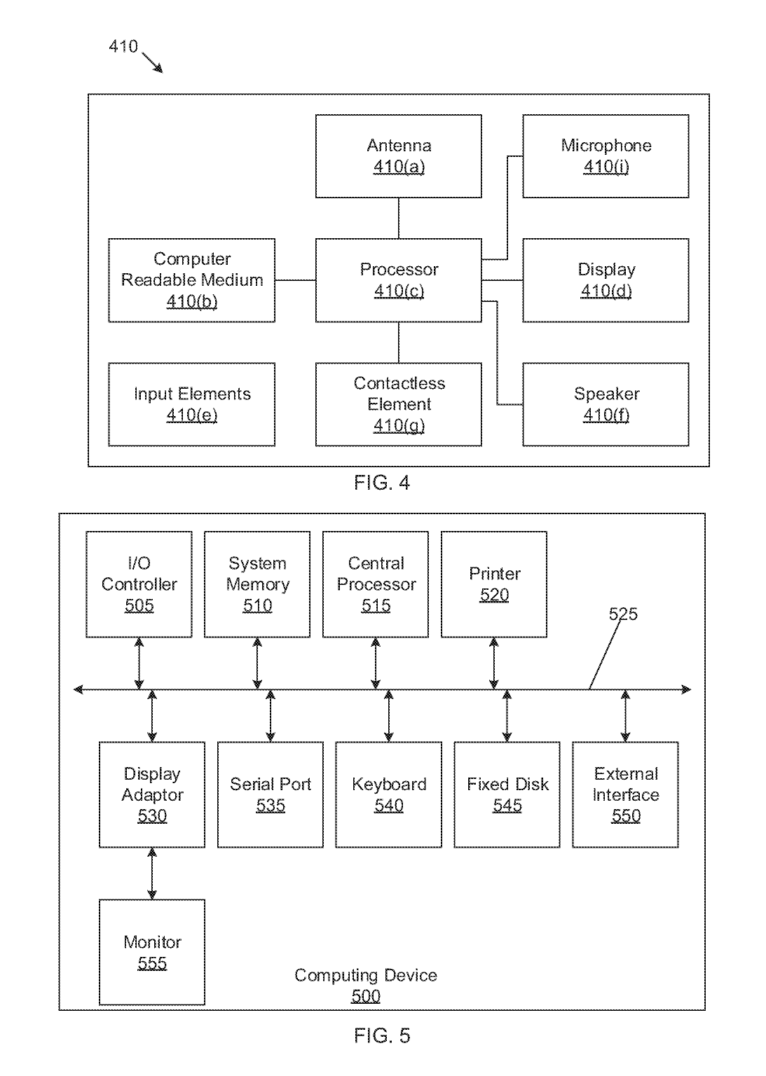

FIG. 4 shows a block diagram of an electronic device being a mobile phone (410) that can be used in embodiments of the invention. The phone can be a notification device that can receive alert messages and access reports, a portable merchant device that can be used to transmit control data identifying a discount to be applied, as well as a portable consumer device that can be used to make payments. The exemplary phone (410) may comprise a computer readable medium and a body as shown in FIG. 4. A computer readable medium (410(b)) may be in the form of (or may be included in) a memory that stores data (e.g., issuer account numbers, loyalty provider account numbers, etc.). The memory may store control data identifying a discount to be applied. The memory may also store information such as financial information, transit information (e.g., as in a subway or train pass), access information (e.g., as in access badges), etc. Financial information may include information such as bank account information, loyalty account information (e.g., a loyalty account number), a bank identification number (BIN), credit or debit card number information, account balance information, expiration date, consumer information such as name, date of birth, etc. Any of this information may be transmitted by the phone (410).

The phone (410) may further include a contactless element (410(g)), which is typically implemented in the form of a semiconductor chip (or other data storage element) with an associated wireless transfer (e.g., data transmission) element, such as an antenna. The contactless element (410(g)) may be associated with (e.g., embedded within) the phone (410) and data or control instructions transmitted via a cellular network may be applied to the contactless element (410(g)) by means of a contactless element interface (not shown). The contactless element interface may function to permit the exchange of data and/or control instructions between the mobile device circuitry (and hence the cellular network) and an optional contactless element (410(g)).

The contactless element (410(g)) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as RFID, Bluetooth, infra-red, or other data transfer capability that can be used to exchange data between the phone (410) and an interrogation device. Thus, the phone (410) may be capable of communicating and transferring data and/or control instructions via both a cellular network and near field communications capability.

The phone (410) may also include a processor (410(c)) (e.g., a microprocessor) for processing the functions of the phone (410) and a display (410(d)) to allow a consumer to see the phone numbers, messages and other information. The phone (410) may further include input elements (410(e)) to allow a user to input information into the device, a speaker (410(f)) to allow the user to hear voice communication, music, etc., and a microphone (410(i)) to allow the user to transmit his or her voice through the phone (410). The phone (410) may also include an antenna (410(a)) for wireless data transfer (e.g., data transmission).

FIG. 5 illustrates an example of a computing device (500) in which various aspects of the disclosure may be implemented. The various participants and elements in the previously described system diagrams may use any suitable number of subsystems in the computing device (500) to facilitate the functions described herein. Examples of such subsystems or components are shown in FIG. 5. The subsystems shown in FIG. 5 are interconnected via a system bus (525).

Additional subsystems such as a printer (520), a keyboard (540), a fixed disk (545) (or other memory comprising computer-readable media), a monitor (555), which is coupled to a display adapter (530), and others are shown. Peripherals and input/output (I/O) devices (not shown), which couple to an I/O controller (505), can be connected to the computing device (500) by any number of means known in the art, such as a serial port (535). For example, the serial port (535) or an external interface (550) can be used to connect the computing device (500) to a wide area network such as the Internet, a mouse input device, or a scanner. The interconnection via the system bus (525) allows a central processor (515) to communicate with each subsystem and to control the execution of instructions from system memory (510) or the fixed disk (545), as well as the exchange of information between subsystems. System memory (510) and/or the fixed disk (545) may embody a computer-readable medium.

A system and method for enabling recurring payments to be processed against an account identifier by only one merchant is therefore provided. The system and method disclosed may alleviate at least some of the restrictions associated with conventional “one-time” payment credentials. Particularly, to the extent that such payment credentials cannot be used for a recurring transaction, the system and method described allows a consumer to request a set of payment credentials which can specifically be used for a recurring payment in favor of one merchant.

Furthermore, the system and method of the invention may obviate or reduce security risks commonly associated with recurring payments. For example, the account identifier may be pseudo-card details which is associated and replaced with actual payment credentials if the transaction is allowed to proceed. The consumer is therefore not required, in such a case, to present actual payment card details to a merchant, which reduces the risk of actual card details being intercepted by fraudulent parties.

Additionally, the consumer may be allowed to cancel or invalidate the single-merchant account identifier at any time after the generation thereof in order to stop any further payments being processed against the single-merchant account identifier. This may reduce the administrative burden often associated with modifying or revoking a recurring payment. Furthermore, the account identifier may simply be cancelled by the consumer if the consumer becomes aware that an unscrupulous party has obtained or received details of the token.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method of enabling payments to be processed against an account identifier by only one merchant, the method carried out at a remotely accessible server having a processor to control the execution of instructions from a memory and comprising:
in response to a consumer electing to generate an account identifier, obtaining an account identifier and storing the account identifier in a database as an unlinked account identifier;
receiving a request originating from an acquiring entity to process a payment transaction against the account identifier;
receiving a merchant identifier of a merchant in favor of which the payment transaction is to be processed;
looking up the account identifier in the database;
storing the merchant identifier in the database in association with the account identifier so as to link the account identifier to the merchant; and
upon subsequent requests originating from an acquiring entity to process a payment transaction against the account identifier:
receiving a merchant identifier of a merchant in favor of which the subsequent payment transaction is to be processed; and
if the merchant identifier of the merchant in favor of which the subsequent payment transaction is to be processed matches the merchant identifier associated with the account identifier, allowing the payment transaction to proceed; or
if the merchant identifier of the merchant in favor of which the subsequent payment transaction is to be processed does not match the merchant identifier associated with the account identifier, declining the payment transaction.

2. The method as claimed in claim 1, wherein the step of storing the merchant identifier in the database in association with the account identifier includes storing the merchant identifier in association with the account identifier only if the account identifier has not previously been used to process a payment transaction.

3. The method as claimed in claim 2, wherein the step of storing the merchant identifier in the database in association with the account identifier is followed by the step of allowing the payment transaction to proceed.

4. The method as claimed in claim 1, wherein the account identifier includes a primary account number (PAN).

5. The method as claimed in claim 1, wherein at least part of the account identifier is formatted as a primary account number (PAN).

6. The method as claimed in claim 1, wherein the account identifier is a token associated with a financial account of the consumer.

7. The method as claimed in claim 6, wherein the step of obtaining the account identifier includes requesting a token generator to generate the account identifier and receiving the account identifier from the token generator.

8. The method as claimed in claim 6, wherein the token is associated with actual payment credentials for the financial account of the consumer, and wherein the actual payment credentials are used to process the payment transaction if the payment transaction is allowed to proceed.

9. The method as claimed in claim 1, wherein the step of obtaining the account identifier includes generating the account identifier at the remotely accessible server.

10. The method as claimed in claim 1, wherein the payment transaction to be processed is a recurring payment.

11. The method as claimed in claim 1, wherein the remotely accessible server is operated by a mobile payment system, wherein the consumer elects to generate the account identifier via an electronic device of the consumer, and wherein an identifier of the electronic device serves as a consumer identifier.

12. A system for enabling payments to be processed against an account identifier by only one merchant, comprising a remotely accessible server having a processor to control the execution of instructions from a memory and including:
an account identifier component for, in response to a consumer electing to generate an account identifier, obtaining an account identifier and storing the account identifier in a database as an unlinked account identifier;
a processing request component for receiving a request originating from an acquiring entity to process a payment transaction against the account identifier;
a merchant identifier component for receiving a merchant identifier of a merchant in favor of which the payment transaction is to be processed;
a look-up component for looking up the account identifier in the database;
a linking component for storing the merchant identifier in the database in association with the account identifier so as to link the account identifier to the merchant; and
an authorization component for, upon subsequent requests originating from an acquiring entity to process a payment transaction against the account identifier and in response to receiving a merchant identifier of a merchant in favor of which the subsequent payment transaction is to be processed:
if the merchant identifier of the merchant in favor of which the subsequent payment transaction is to be processed matches the merchant identifier associated with the account identifier, allowing the payment transaction to proceed; or
if the merchant identifier of the merchant in favor of which the subsequent payment transaction is to be processed does not match the merchant identifier associated with the account identifier, declining the payment transaction.

13. The system as claimed in claim 12, further comprising a token generator, wherein the step of obtaining an account identifier performed by the account identifier component of the remotely accessible server includes requesting the token generator to generate the account identifier and receiving the account identifier from the token generator.

14. The system as claimed in claim 13, wherein the account identifier is a token associated with a financial account of the consumer, and wherein the token generator is an issuer of the financial account of the consumer.

15. A system for enabling payments to be processed against an account identifier by only one merchant, comprising an electronic device of a consumer in communication with a remotely accessible server, the electronic device including:
an electing component for receiving input from the consumer indicating election to generate an account identifier;
a transmitting component for transmitting a request for an account identifier, the remotely accessible server obtaining the account identifier in response to the request; and
a receiving component for receiving the account identifier such that the account identifier can subsequently be provided to a merchant in favor of which a payment transaction is to be processed.

16. The system as claimed in claim 15, wherein the electronic device of the consumer is a mobile phone, wherein the remotely accessible server is operated by a mobile payment system, and wherein an identifier of the mobile phone serves as a consumer identifier.

17. A computer program product for enabling payments to be processed against an account identifier by only one merchant, the computer program product comprising a computer-readable medium having stored computer-readable program code for performing the steps of:
in response to a consumer electing to generate an account identifier, obtaining an account identifier and storing the account identifier in a database as an unlinked account identifier;
receiving a request originating from an acquiring entity to process a payment transaction against the account identifier;
receiving a merchant identifier of a merchant in favor of which the payment transaction is to be processed;
looking up the account identifier in the database;
storing the merchant identifier in the database in association with the account identifier so as to link the account identifier to the merchant; and
upon subsequent requests originating from an acquiring entity to process a payment transaction against the account identifier:
receiving a merchant identifier of a merchant in favor of which the subsequent payment transaction is to be processed; and
if the merchant identifier of the merchant in favor of which the subsequent payment transaction is to be processed matches the merchant identifier associated with the account identifier, allowing the payment transaction to proceed; or
if the merchant identifier of the merchant in favor of which the subsequent payment transaction is to be processed does not match the merchant identifier associated with the account identifier, declining the payment transaction.
